(19) United States
(12) Patent Application Publication
(10) Pub. No.: US 2025/0257210 A1
(43) Pub. Date: Aug. 14, 2025

(54) METHOD FOR PRODUCING A COMPOSITE COMPONENT WITH A SUPPORT COMPRISING POLYCARBONATE OF A SPECIFIC OH CONTENT

(71) Applicant: Covestro Deutschland AG, Leverkusen (DE)

(72) Inventors: Benjamin Herzberg, Köln (DE); Michael Delbeck, Issum (DE); Alexander Meyer, Düsseldorf (DE); Thomas Grimm, Köln (DE); Christoph Klinkenberg, Köln (DE); Ruediger Hahn, Burscheid (DE)

(21) Appl. No.: 18/881,765

(22) PCT Filed: Jul. 11, 2023
(86) PCT No.: PCT/EP2023/069171

§ 371 Date: Jan. 7, 2025

(30) Foreign Application Priority Data
Jul. 18, 2022 (EP) 22185585.1
Jul. 18, 2022 (EP) 22185586.9

(51) Int. Cl. C08L 69/00; B29C 45/14; B29C 67/24; B29K 275/00; B29K 669/00; B32B 27/08; B32B 27/36; B32B 27/40; C08L 75/04

(52) U.S. Cl. CPC C08L 69/00; B29C 67/246; B32B 27/08; B32B 27/365; B32B 27/40; C08L 75/04; B29C 45/14; B29K 2275/00; B29K 2669/00; C08L 2203/30

(57) ABSTRACT

The present invention relates to a method for producing composite components with improved interlaminar bonding, the components comprising a carrier, comprising polycarbonate and at least one polyurethane layer that is in direct contact with this carrier. The invention also relates to composite components with improved interlaminar bonding, and to the use of a polycarbonate with defined OH content as a carrier material in the production of composite components with improved interlaminar bonding.

The present invention relates to a process for producing composite component parts having improved composite adhesion, wherein these comprise a carrier comprising polycarbonate and at least one polyurethane layer in direct contact with this carrier. The invention also relates to composite component parts having improved composite adhesion and to the use of a polycarbonate having a defined OH content as a carrier material in the production of composite component parts having improved composite adhesion.

Composite component parts comprising a carrier composed of a thermoplastic and at least one polyurethane layer in direct contact with this carrier are known in the prior art. Solid coated molded parts for example may be produced by processes such as the RIM process (reaction injection molding). A particularly advantageous method of producing composite component parts having coatings of high layer thickness is so-called in mold coating (IMC) or else direct coating (DC). This comprises applying the coating components to the corresponding carrier in a mold and curing in the mold cavity. In addition to the abovementioned requirements the great advantages of IMC technology include the rapid processing times, a low to lower loss of raw materials and the production of a coated injection molded part (composite component part) including the coating in one operation. The composite component parts obtained both by RIM processes and by IMC processes exhibit the mechanical properties of the carrier material, though the weathering stability and scratch resistance thereof is improved by the polyurethane layer. It goes without saying here that the overall performance and overall stability of the composite component part is also determined by the adhesion of the polyurethane layer to the carrier. Commonly used composite component parts comprising polycarbonate as the carrier material often exhibit an adhesion loss after subjection to stresses such as the environmental cycle test or storage. This also reduces the overall performance of the composite component part. Another advantage of the RIM and IMC processes is that these processes make it possible to produce specific designs not obtainable by other processes. This is especially because the coating of the composite component parts may be made relatively thick and at the same time reacts quickly.

DE 196 50 854 C1 discloses such an IMC process for producing a multilayer plastic part where a plastic injection molded part is coated with at least one layer of a 2-component duromer, preferably polyurethane. In this process the plastic part and the layer of 2-component duromer are consecutively injected in the same mold in a cycle-synchronous fashion. DE 196 50 854 C1 gives no indication about the effect of the nature of the carrier material and the process parameters on the adhesion between the carrier material and the layer of the composite component part in contact therewith.

WO 2006/072366 A1 describes a process for forming and coating a substrate in a mold having at least two cavities. The process comprises the steps of:
A) forming a substrate in a first cavity of the mold;
B) introducing the substrate produced in the preceding step into a second cavity of the mold and
C) coating the substrate in the second cavity with a lacquer, wherein the coating is carried out under elevated pressure.

In this document too the adhesion between the carrier material and the lacquer layer is not the focus.

EP28990008A1 describes that a special surface structuring of the carrier can improve the adhesion to the polyurethane layer. It is likewise known that the use of primers or a special activation of the carrier material can result in improved adhesion.

WO2011/015286 A1 relates to the provision of an improved bond between the carrier material and the polyurethane layer with the proviso that no modification of the surface (in particular primers or surface activation) of the carrier is required. It was found that the use of a foamed carrier material has a positive effect on the adhesion to the polyurethane layer. WO2011/070044 A4 investigates the effect of the rubber content of a composition containing polycarbonate and a rubber-modified vinyl(co)polymer as carrier material on composite adhesion.

The improvement in bond adhesion is achieved in these documents either by additional steps such as application of a primer, surface activation, surface structuring or foaming of the carrier material, or by adding additives to the composition of the carrier material. This either means that an additional step associated with corresponding costs and complexity is required in the production of the composite part. Or else a specifically additized composition of the carrier material is required which has an effect on the mechanical properties and optical properties of the resulting composite component part and is likewise associated with additional costs for the additive.

Proceeding from this prior art, it is an object of the present invention to overcome at least one disadvantage of the prior art. It was especially the object of the present invention to provide a composite component part having an improved bond between the carrier material comprising polycarbonate and the at least one polyurethane layer in contact directly with the carrier material. Preferably, no additional steps such as modification of the surface by a primer or surface activation should be necessary. The use of additional additives for the purpose of improving/increasing composite adhesion in the carrier material should likewise be avoided. In particular the polyurethane raw material mixture used for producing the composite component part should be highly reactive (i.e. preferably have a mold residence time of less than 150 s, preferably 100 s). The employed polyurethane raw material mixture should further preferably have a pot life of at most 30 seconds, preferably at most 10 seconds. The composite component part should very particularly preferably be produced by an RIM or IMC process, in particular an IMC process.

At least one, preferably all, of the aforementioned objects have been achieved by the present invention. It has surprisingly been found that the use of a polycarbonate having a defined OH number as carrier material results in an improved bond between the carrier material and the at least one polyurethane layer in direct contact with the carrier material. The resulting composite composite exhibits non-positive adhesion. This can be assessed in particular by testing using the POSI test (according to DIN EN ISO 4624:2016-08, using method B (8.4.2), optionally indicating the most damaged defect pattern). In a departure from the DIN standard it is preferable to perform 8 measurements per component part and analyze a total of 3 component parts. The median of the measurements gives the adhesion value. The initial adhesion of the composite component part according to the invention is preferably at least 5 MPa measured by the aforementioned POSI test. The adhesion of the composite component part according to the invention after a hydrolysis test (i.e. after 72 h storage at 90±2° C. and 95±3% relative humidity in the conditioning cabinet (formation of water droplets on the component part is to be avoided by suitable positioning in the conditioning chamber)) is preferably also at least 2 MPa measured by the aforementioned POSI test. The composite adhesion between the carrier composed of polycarbonate composition and the polyurethane coating in the composite component parts according to the invention can also be measured on strip specimens taken from the component part having a width of 20 mm in a wheel peel test according to DIN 53357:1982-10 at a test speed of 100 mm/min.

The composite shows an improvement especially relative to a comparable system, the polycarbonate, however, having an OH number below the OH number according to the invention. At the same time a person skilled in the art is aware that the OH number of a polycarbonate is to be kept as low as possible since an excessively high OH content has an adverse effect on the heat stability of the polycarbonate. Such a polycarbonate has a tendency to undergo yellowing when heated. It has been found according to the invention that the specifically defined range of OH groups in the employed polycarbonate on the one hand efficaciously improves the composite adhesion but on other hand is still low enough to ensure that the resulting composite component part exhibits good heat stability. Without wishing to be tied to a particular theory it is thought that especially the OH groups present at the surface of the carrier formed are available for reaction with the components of the polyurethane raw material mixture. This leads to formation of bonds, preferably covalent bonds, between the surface of the carrier and the polyurethane layer being formed. This results in good bonding in the resulting composite component part. This effect is particularly pronounced in the RIM and/or IMC process since polyurethane raw material mixtures generally having a high isocyanate content are employed there. This allows the described reaction to proceed particularly effectively.

In one aspect the invention thus provides a process for producing a composite component part comprising
a) a carrier composed of a thermoplastic composition and
b) at least one polyurethane layer in direct contact with the carrier.
comprising the steps of
   (i) injecting a melt of the thermoplastic composition
   into a mold cavity followed by cooling to form the carrier, wherein the thermoplastic composition contains
   A) at least 95.0% by weight of an aromatic polycarbonate having a phenolic OH content of 230 ppm to 1500 ppm and
   B) 0% to 5.0% by weight of at least one polymer additive.
   (ii) enlarging the cavity of the mold and thus producing a gap or introducing the carrier into a second cavity of the mold which is larger than the first cavity in terms of its hollow mold dimensions, thus producing a gap.
   (iii) injecting a reactive polyurethane raw material mixture containing
at least one polyisocyanate component.
at least one polyfunctional H-active compound and
optionally at least one polyurethane additive and/or processing auxiliary.
into the gap between the carrier and the mold surface, wherein the polyurethane raw material mixture undergoes polymerization to afford a compact polyurethane layer or to afford a polyurethane foam layer in contact with the surface of the carrier.
   (iv) demolding the composite component part from the mold cavity.

In one aspect the invention thus likewise provides a process for producing a composite component part comprising
a) a carrier composed of a thermoplastic composition and
b) at least one polyurethane layer in direct contact with the carrier.
comprising the steps of
   (i) (ia) injecting a melt of a thermoplastic composition (Z) into a mold cavity followed by cooling to form the carrier or (ib) introducing a film comprising an outer ply composed of a thermoplastic composition (Z) into a mold cavity, overmolding this film with a melt of a further thermoplastic composition (Z2) on the side facing away from the outer ply of the film followed by cooling to form the carrier.
wherein the thermoplastic composition (Z) contains
A) at least 95.0% by weight of an aromatic polycarbonate having a phenolic OH content of 230 ppm to 1500 ppm and
B) 0% to 5.0% by weight of at least one polymer additive and wherein the further thermoplastic composition (Z2) may be the same as or different from the thermoplastic composition (Z),
   (ii) enlarging the cavity of the mold and thus producing a gap or introducing the carrier into a second cavity of the mold which is larger than the first cavity in terms of its hollow mold dimensions, thus producing a gap, and wherein in case (ib) the carrier is oriented such that the outer ply of the film composed of the thermoplastic composition (Z) faces the gap,
   (iii) injecting a reactive polyurethane raw material mixture containing
at least one polyisocyanate component.
at least one polyfunctional H-active compound and
optionally at least one polyurethane additive and/or processing auxiliary.
into the gap between the carrier and the mold surface, wherein the polyurethane raw material mixture undergoes polymerization to afford a compact polyurethane layer or to afford a polyurethane foam layer in contact with the surface of the carrier,
(iv) demolding the composite component part from the mold cavity.

It is apparent to a person skilled in the art that step (i) is divided into two alternative substeps (ia) oder (ib). All elucidations relate either to step (i) without subdivision and/or to step (i) with subdivision into step (ia) and (ib). It is also apparent to a person skilled in the art that the thermoplastic composition comprising the inventive proportion of phenolic OH content is in prenciple referred to as “thermoplastic composition” and/or also as “thermoplastic composition (Z)”. There is no difference here. However, a distinction is to be made in the case where step (i) comprises step (ib) because in this case a further thermoplastic composition is employed which is sometimes also referred to as “thermoplastic composition (Z2)”. According to the invention this may be the same as or different from the thermoplastic composition (Z).

According to the invention it is preferable when process steps (i) to (iv) are immediately consecutive. However, in this case the process steps (i), (ii) and/or (iii), preferably (ii) and (iii) may be performed several times (but need not be). If process step (i) is performed two or more times it is preferable when the employed thermoplastic composition in the second step and optionally also in every further process step (i) differs from the thermoplastic composition (Z) of the first process step (i). However, it is a requirement that the carrier material which results from step (i) and which is in direct contact with the polyurethane raw material mixture in process step (iii) is the thermoplastic composition (Z) according to the invention which comprises the defined phenolic OH content. The immediate succession of the process steps (i) to (iv) prevents the temperature of the workpiece cooling to room temperature during the process. This achieves a reduction in production times and a higher energy efficiency of the overall process.

The process steps (ii) and (iii) may be repeated at least once while varying the polyurethane system to apply one or more polyurethane layers only onto one or both sides of the carrier to afford a composite component part composed of a thermoplastic carrier and at least two identical or different PU components having optionally also more than bilayered construction. If process steps (ii) and (iii) are repeated it is apparent to a person skilled in the art that at least the second polyurethane layer is then no longer in direct contact with the support.

A gap is produced in process step (ii). The term “gap” is understandable to a person skilled in the art. It preferably describes a cavity which is sealed off from the environment so that no material can escape. To produce the gap in process step (ii) it is possible either to open the injection mold and subsequently replace one half of the injection mold cavity with a new half having larger hollow mold dimensions or to move the component part from the first mold cavity into a second cavity, larger in terms of its hollow mold dimensions, of the same mold or of a second mold, or to open the first cavity by a gap width. Process step (ii) thus comprises enlarging the cavity of the mold and thus producing a gap or introducing the carrier into a second cavity of the mold which is larger than the first cavity in terms of its hollow mold dimensions, thus producing a gap. It is preferable when process step (ii) comprises introducing the carrier into a second cavity of the mold which is larger than the first cavity in terms of its hollow mold dimensions, thus producing a gap. If according to the invention process step (ib) is performed it is apparent to a person skilled in the art that in process step (ii) the carrier from process step (i) is oriented such that the outer ply of the film composed of the thermoplastic composition (Z) faces the gap. This is evident because the improved composite adhesion found according to the invention can only be achieved in this way. This requires direct contact of the thermoplastic composition (Z) with the polyurethane layer. A person skilled in the art is thus aware of how the carrier of process step (ib) must be oriented relative to the gap into which the reactive polyurethane raw material mixture is injected.

The movement of the substrate in process step (ii) may be carried out by known methods as are used for example in multicolor injection molding. Typical methods are movement with a turntable, a turning plate, a sliding cavity or an index plate, or comparable methods in which the substrate remains on a core. If the substrate to be moved remains on the core, this has the advantage that the position is defined accurately even after the displacement. On the other hand, the prior art discloses methods of moving a substrate in which the substrate is removed from a cavity, for example with the aid of a handling system, and placed into another cavity. Movement with removal of the substrate offers greater freedom of configuration in the coating operation, for example in the generation of an edge fold or masked regions. It is also possible to produce structured lacquer surfaces which likewise entails a greater degree of design freedom.

The process according to the invention also encompasses the possibility of providing the carrier by means of film-insert molding as known to those skilled in the art. To this end in process step (i) according to (ib) a film comprising an outer ply composed of the thermoplastic composition (Z) is introduced into a mold cavity, this film is overmolded with a melt of a further thermoplastic composition (Z2) on the side facing away from the outer ply of the film and subsequently cooled to form the carrier. This process accordingly provides a carrier in a manner similar to when in process step (i) according to (ia) a melt of a thermoplastic composition (Z) is injected into a mold cavity and subsequently cooled. In both cases a carrier comprising the thermoplastic composition at least on one side is formed. According to the invention said composition is subsequently contacted with the reactive polyurethane raw material mixture. However, since the carrier according to (ib) may also be formed by a layer construction of a further thermoplastic composition (Z2) and the film, the cross section of the carriers according to (ia) and (ib) can differ.

According to the invention it is apparent that the term “carrier” comprises both a classical substrate and a multilayer construction composed of the substrate and a film. A substrate differs from a multilayer construction of a substrate and a film in that the substrate is generally only formed in the mold cavity by injection of a melt (may also be referred to as an injection molded component part). By contrast, in the multilayer construction of a substrate and a film the film is initially introduced into the mold cavity in an inherently solidified form. To prevent slipping, the film may preferably be secured using a vacuum, static charge or by mechanical anchoring in the mold cavity. It cannot be ruled out that the film undergoes at least partial deformation in the course of the process according to the invention (for example through temperature elevation). This film is subsequently overmolded with a further thermoplastic composition which forms the actual substrate of the multilayer construction, comprising a substrate and a film, by cooling. However, according to the invention substrate and multilayer construction composed of substrate with film are preferably delimited at the time of first introduction into the mold cavity. In the first case a melt is introduced while in the latter case a solid which is subsequently overmolded with a melt is introduced.

The employed film has an outer ply composed of the thermoplastic composition (Z). The film may be a single-ply or multi-ply film. If it is multi-ply, at least one of the outer layers is a ply composed of the thermoplastic composition (Z). If it is only single-ply, the outer ply is the actual film, thus obviating an orientation or which side of the film is overmolded, as is apparent to a person skilled in the art who has understood the invention especially in relation to achieving the better composite adhesion. The film may also be composed of the ply containing the thermoplastic composition (Z). According to the invention a ply is preferably to be understood such that it is a shaped article whose extent in the plane is many times greater than its thickness. The surface of the film may be even more structured. A structured surface is also referred to as a ply unless otherwise stated. The film may comprise at least one ply.

The employed film may preferably be at least partially coated on at least one side. However, it is apparent to a person skilled in the art that this coating, provided it does not contain the thermoplastic composition (Z) used according to the invention, is brought into direct contact/is in direct contact with the further thermoplastic composition (Z2). Such a coating of the film generally represents the side referred to in process step (ib) as the side facing away from outer ply of the film. The film May be coated by screenprinting, by vacuum or else by other known coating techniques. Paints, metals or the like may be employed as coating materials. It is likewise possible according to the invention to employ a film composite. The simplest embodiment is a trilayered construction composed of a plastic film, a metal film for example and then another plastic film. The advantage of such a construction is that the coating is protected. At least one of the outer plies of the film is composed of the thermoplastic composition (Z) employed according to the invention.

The process according to the invention is preferably characterized in that at at least one point the carrier has a wall thickness of 0.5 mm to 10 mm, preferably 1 mm to 9 mm, particularly preferably 1.5 mm to 6.5 mm and very preferably 2 mm to 5 mm.

The polyurethane there may be for example a PU lacquer, a PU foam or a compact PU skin. According to the invention all of these embodiments are subsumed under the term “polyurethane layer”. The polyurethane layers produced by this process may have thicknesses of for example 1 μm to 20 cm, preferably 5 μm to 15 cm, particularly preferably 10 μm to 10 cm. The process according to the invention is preferably characterized in that the polyurethane layer has a layer thickness of 1-1500 μm, preferably more than 1.5 mm-10 mm, particularly preferably more than 1 cm-20 cm, likewise preferably 500 μm bis 1 mm. In all of these configurations the polyurethane layer may also be foamed.

The reactive polyurethane raw material mixture preferably has an index of >90 to <140, preferably >100 to <120 and particularly preferably from 105 to 115. The index is defined as the percentage ratio of the amount of isocyanate actually used to the calculated stoichiometric amount in the case of complete polyol conversion (i.e. for conversion of the OH-equivalent calculated amount of isocyanate groups) i.e. index=((functionality of isocyanates*molar amount of total isocyanates)/(functionality of alcohols*molar amount of total hydroxy groups))*100.

It is preferable when the surface of the injection mold contacting the thermoplastic polymer composition in process step (iii) is heated to a temperature in the range from 50° C. to 140° C. preferably 60° C. to 100° C. and particularly preferably 65° C. to 95° C. preferably 60° C. to 85° C. and particularly preferably 60° C. to 80° C. Alternatively it is particularly preferable when the surface of the injection mold contacting the thermoplastic polymer composition in process step (iii) is heated to a temperature in the range from 50° C. to 150° C. preferably 60° C. to 140° C. and particularly preferably 70° C. to 130° C. preferably 80° C. to 120° C. and particularly preferably 90° C. to 110° C. These values especially apply when the carrier material comprises as component A) a polycarbonate based on bisphenol A. If a different copolycarbonate were to be used a person skilled in the art is capable on the basis of the glass transition temperature of this other (co)polycarbonate to correspondingly adapt preferred temperatures. It is likewise preferable when the surface of the injection mold contacting the reactive polyurethane mixture in process step (iii) is heated to a temperature in the range from 50° C. to 160° C. preferably 70° C. to 120° C. more preferably 80° C. to 110° C. and particularly preferably 90° C. to 100° C. It is further preferable when in process step (iii) the temperature of the polyurethane-side mold cavities at least 10° C. preferably at least 15° C. particularly preferably at least 20° C. higher than the temperature of the carrier-side (thermoplastic-side) mold cavity. However, it is also possible to perform process step (iii) without a temperature delta between the polyurethane-side and the carrier-side mold cavity.

It is likewise preferable when polymerization in process step (iii) is carried out under elevated pressure. It is especially preferable when the pressure in process step (iii) is in the range from 10 bis 150 bar, preferably 10 bis 90 bar (10 000 t 90 000 hPa). It is likewise preferable when in process step (iii) the reactive polyurethane of raw material mixture is introduced with high-pressure or low-pressure apparatuses. Before demolding of the workpiece in steps (ii) and (iv) the workpiece is cooled until dimensional stability is achieved.

The composite component parts produced according to the invention are preferably suitable for use as interior or exterior component parts of a rail vehicle, aircraft or motor vehicle.

### Component A

Aromatic polycarbonates according to component A which are suitable in accordance with the invention are known from the literature or producible by processes known from the literature (for production of aromatic polycarbonates see, for example. Schnell. “Chemistry and Physics of Polycarbonates”, Interscience Publishers, 1964, and also DE-B 1 495 626, DE-A 2 232 877, DE-A 2 703 376, DE-A 2 714 544, DE-A 3 000 610, DE-A 3 832 396; for production of aromatic polyestercarbonates, for example DE-A 3 077 934). Aromatic polycarbonates of component A) in the context of the present invention include not only homopolycarbonates but also copolycarbonates and/or polyestercarbonates: the polycarbonates may be linear or branched in known fashion. It is also possible according to the invention to employ mixtures of polycarbonates.

A polycarbonate or a material “based on” polycarbonate according to the present invention is a thermoplastic material which preferably comprises at least 50% by weight, particularly preferably at least 60% by weight and particularly preferably at least 70% by weight of polycarbonate.

A portion of up to 80 mol %, preferably of 20 mol % to 50 mol %, of the carbonate groups in the polycarbonates used according to the invention may be replaced by aromatic dicarboxylic ester groups. Polycarbonates of this type that contain not only acid radicals derived from carbonic acid but also acid radicals derived from aromatic dicarboxylic acids incorporated into the molecular chain are referred to as aromatic polyestercarbonates. In the context of the present invention they are subsumed by the umbrella term “thermoplastic aromatic polycarbonates”.

Replacement of the carbonate groups by the aromatic dicarboxylic ester groups proceeds substantially stoichiometrically and also quantitatively and the molar ratio the reactants is therefore also reflected in the final polyestercarbonate. The aromatic dicarboxylic acid groups may be incorporated in both random and blockwise fashion. In the context of the present invention polyestercarbonates are encompassed by the term “polycarbonates”.

In the context of the present invention the term “alkyl” or “alkyl group” preferably refers, unless otherwise stated, to an alkane structure from which a hydrogen atom has been removed. The alkyl group according to the present invention may be linear or branched. It is saturated and therefore comprises only single bonds between the adjacent carbon atoms. It is preferable when the alkyl group comprises methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, 1-ethyl-2-methylpropyl and the like. The selection of these structures may be limited if in the context of the present invention the number of carbon atoms is defined differently.

In the context of the present invention the term “alkylene” or “alkylene group” preferably refers, unless otherwise stated, to a bridging alkane structure from which two hydrogen atoms have been removed from different carbon atoms. In this context, the two hydrogen atoms removed from the two carbon atoms can be removed from any carbon atoms in the alkane structure. This means that the two carbon atoms may be adjacent but need not necessarily be adjacent. An alkylene group may be linear or branched. It is saturated. If the alkylene group comprises only one carbon atom a methylene group (—CH₂—) is concerned which is connected to the remainder of the molecule via two single bonds It is preferable when the alkylene group comprises methylene, ethylene, n-propylene, iso-propylene, n-butylene, sec-butylene, tert-butylene, n-pentylene, 1-methylbutylene, 2-methylbutylene, 3-methylbutylene, neopentylene, 1-ethylpropylene, n-hexylene, 1,1-dimethylpropylene, 1,2-dimethylpropylene, 1,2-dimethylpropylene, 1-methylpentylene, 2-methylpentylene, 3-methylpentylene, 4-methylpenty lenc, 1,1-dimethylbutylene, 1,2-dimethylbutylene, 1,3-dimethylbutylene, 2,2-dimethylbutylene, 2,3-dimethylbutylene, 3,3-dimethylbutylene, 1-ethylbutylene, 2-ethylbutylene, 1,1,2-trimethylpropylene, 1,2,2-trimethylpropylene, 1-ethyl-1-methylpropylene, 1-ethyl-2-methylpropylene, 1-ethyl-2-methylpropylene and the like. The selection of these structures may be limited if in the context of the present invention the number of carbon atoms is defined differently.

In the context of the present invention the term “alkylidene” or “alkylidene group” preferably refers, unless otherwise stated, to a bridging alkane structure from which two hydrogen atoms have been removed from the same carbon atom. It is preferable when the alkylidene group comprises isopropylidene, n-propylidene, isoheptylidene and the like.

Preferred polyestercarbonates are represented by formula (w)

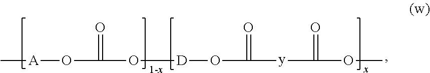

in which
A in each repeating unit independently represents an aliphatic or aromatic divalent group, for example an aromatic divalent group having 6 to 30 carbon atoms, which may contain one or more aromatic rings, may be substituted and may contain aliphatic or cycloaliphatic radicals or alkylaryls or heteroatoms as bridging structures, such as a structure of the formula (wi)

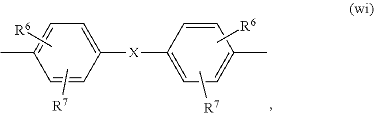

in which
R⁶ and R⁷ are independently H, C₁- to C₁₈-alkyl, C₁- to C₁₈-alkoxy, halogen such as Cl or Br or in each case optionally substituted aryl or aralkyl, preferably H or C₁- to C₁₂-alkyl, particularly preferably H or C₁- to C₈-alkyl and very particularly preferably H or methyl and
X represents a single bond, —SO₂—, —CO—, —O—, —S—, C₁- to C₆-alkylene, C₂- to C₅-alkylidene or C₅- to C₆-cycloalkylidene which may be substituted with C₁- to C₆-alkyl, preferably methyl or ethyl, or else represents C₆- to C₁₂-arylene which may optionally be fused to further heteroatom-containing aromatic rings
or—based on A—an aliphatic divalent group which may be cyclic, linear or branched and which has 2 to 30 carbon atoms which may be interrupted by at least one heteroatom and may comprise more than one cycle, for example structure (wii)

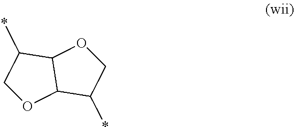 [SMILES: *C1COC2C(*)COC12]

or—based on A—a linear alkylene group having 2 to 22 carbon atoms, preferably 2 to 4 carbon atoms, which may be interrupted by at least one heteroatom, or a branched alkylene group having 4 to 20 carbon atoms, preferably 5 to 15 carbon atoms, which may be interrupted by at least one heteroatom or a cycloalkylene group having 4 to 20 carbon atoms, preferably 5 to 15 carbon atoms, which may be interrupted by at least one heteroatom and which may contain more than one cycle,
D in each repeating unit independently represents A or an aromatic or cycloaliphatic divalent group, preferably an optionally substituted phenylene or an optionally substituted cyclohexylene;
Y in each repeating unit independently represents an aliphatic divalent group, which may be cyclic, linear or branched and comprises 2 to 30 carbon atoms which may be interrupted by at least one heteroatom and which comprises more than one cycle or aromatic divalent group, preferably a linear aliphatic divalent group having 2 to 30 carbon atoms, a branched aliphatic divalent group having 2 to 30 carbon atoms, a cycloaliphatic divalent group having 6 to 30 carbon atoms, which may comprise more than one cycle or an aromatic divalent group having 6 to 30 carbon atoms, particularly preferably an optionally substituted cyclohexylene, an aliphatic linear group having 2 to 18 carbon atoms or an optionally substituted phenylene and

$$0 < x < 1 .$$

Particularly preferred polyestercarbonates are those based on the combination of the following diols and diacids: Bisphenol A and sebacic acid; bisphenol A and isophthalic acid, terephthalic acid and/or phthalic acid and optionally resorcinol; isosorbide and cyclohexanedicarboxylic acid and optionally further diols or diacids.

Dihydroxyaryl compounds suitable for production of the polycarbonates include for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from isatin derivatives or from phenolphthalein derivatives and their ring-alkylated, ring-arylated and ring-halogenated compounds or 9,9-bis(4-hydroxyphenyl)fluorene.

Preferred dihydroxyaryl compounds include 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene, 9,9-bis(4-hydroxyphenyl)fluorene and 1,1-bis(4-hydroxyphenyl)-3,3,5-trimethylcyclohexane and also the bisphenols (I) to (III)

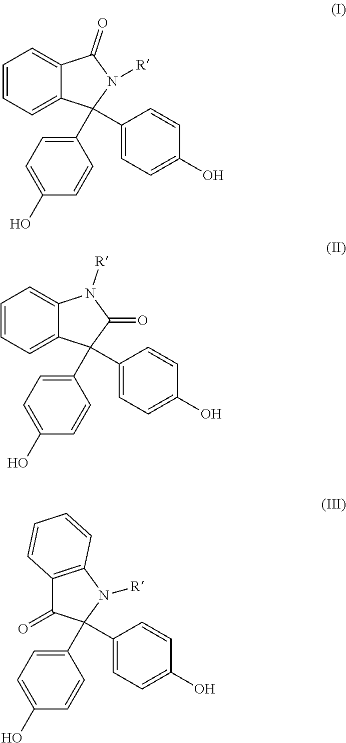

in which R′ in each case represents C₁-C₄-alkyl, aralkyl or aryl, preferably methyl or phenyl, very particularly preferably methyl.

Particularly preferred dihydroxyaryl compounds include 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A and also the dihydroxyaryl compounds of formulae (I), (II) and (III).

These and other suitable dihydroxyaryl compounds are described for example in U.S. Pat. Nos. 3,028,635, 2,999,825, 3,148,172, 2,991,273, 3,271,367, 4,982,014 and 2,999,846, in DE-A 1 570 703, DE-A 2 063 050, DE-A 2 036 052, DE-A 2 211 956 and DE-A 3 832 396, in FR-A 1 561 518, in the monograph H. Schnell, “Chemistry and Physics of Polycarbonates”, Interscience Publishers. New York 1964.

Also preferred are polycarbonates whose production employed a dihydroxyaryl compound of the following formula (1a):

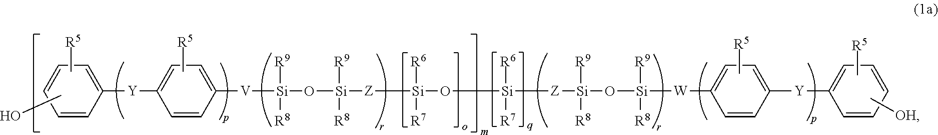

in which
R⁵ represents hydrogen or C1- to C4-alkyl, C1- to C4-alkoxy, preferably hydrogen or methyl or methoxy, particularly preferably hydrogen.
R⁶, R⁷, R⁸ and R⁹ independently represent C6- to C12-aryl or C1- to C4-alkyl, preferably phenyl or methyl, in particular methyl,
Y represents a single bond, SO₂, —S—, —CO—, —O—, C1- to C6-alkylene, C2- to C5-alkylidene, C6- to C12-arylene, which may optionally be condensed with further aromatic rings with heteroatoms, or a C5- to C6-cycloalkylidene radical, which may be mono- or polysubstituted with C1- to C4-alkyl,
preferably a single bond, —O—, isopropylidene or a C5- to C6-cycloalkylidene radical which may be mono- or polysubstituted with C1- to C4-alkyl,
V represents oxygen. C2- to C6-alkylene or C3- to C6-alkylidene, preferably oxygen or C3-alkylene,
p, q and r are each independently 0 or 1.
wherein when q=0, W is a single bond, when q=1 and r=0, W represents —O—, C2- to C6-alkylene or C3- to C6-alkylidene, preferably —O— or C3-alkylene,
when q=1 and r=1, W and V independently represent C2- to C6-alkylene or C3- to C6-alkylidene, preferably C3-alkylene,
Z represents C1- to C6-alkylene, preferably C2-alkylene,
is an average number of repeating units from 10 to 500, preferably 10 to 100, and
m is an average number of repeating units from 1 to 10, preferably 1 to 6, particularly preferably 1.5 to 5.

It is likewise possible to employ dihydroxyaryl compounds where two or more siloxane blocks of general formula (1a) are linked via terephthalic acid and/or isophthalic acid to form ester groups.

Copolycarbonates comprising monomer units of general formula (1a), in particular comprising bisphenol A, and in particular the production of these copolycarbonates are described for example in WO 2015/052106 A2.

It is likewise possible to employ dihydroxyaryl compounds where two or more siloxane blocks of general formula (1a) are linked via terephthalic acid and/or isophthalic acid to form ester groups.

The polycarbonates are produced in a known manner from diphenols, carbonic acid derivatives, optionally chain terminators and optionally branching agents, and the polyester carbonates are produced by replacing a portion of the carbonic acid derivatives with aromatic dicarboxylic acids or derivatives of the dicarboxylic acids, to a degree according to the extent to which the carbonate structural units in the aromatic polycarbonates are to be replaced by aromatic dicarboxylic ester structural units.

In the case of homopolycarbonates only one diphenol is used and in the case of copolycarbonates two or more diphenols are used. The diphenols used, like all other chemicals and auxiliaries added to the synthesis, may be contaminated with the impurities from their own synthesis, handling, and storage. It is however desirable to use raw materials of the highest possible purity.

The monofunctional chain terminators required for molecular-weight regulation, for example phenols or alkylphenols, in particular phenol, p-tert-butylphenol, isooctylphenol, cumylphenol, chlorocarbonic esters thereof or acyl chlorides of monocarboxylic acids or mixtures of these chain terminators, are either supplied to the reaction with the bisphenoxide(s) or else are added at any desired juncture in the synthesis provided that phosgene or chlorocarbonic acid end groups are still present in the reaction mixture or, in the case of acyl chlorides and chlorocarbonic esters as chain terminators, as long as sufficient phenolic end groups of the incipient polymer are available. However, it is preferable when the chain terminator(s) is/are added after the phosgenation at a location or at a juncture at which phosgene is no longer present but the catalyst has not yet been added or when they are added before the catalyst or together or in parallel with the catalyst. Any branching agents or branching agent mixtures to be used are added to the synthesis in the same manner, but typically before the chain terminators. Compounds typically used are trisphenols, quaterphenols or acyl chlorides of tri- or tetracarboxylic acids, or else mixtures of the polyphenols or of the acyl chlorides. Examples of some of the compounds usable as branching agents and having three or more than three phenolic hydroxyl groups include phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tris(4-hydroxyphenyl)benzene, 1,1,1-tri(4-hydroxyphenyl)ethane, tris(4-hydroxy phenyl)phenylmethane, 2,2-bis[4,4-bis(4-hydroxyphenyl)cyclohexyl]propane, 2,4-bis(4-hydroxy phenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole, Preferred branching agents are 3,3-bis(3-methyl-4-hydroxyphenyl)-2-oxo-2,3-dihydroindole and 1,1,1-tri(4-hydroxyphenyl)ethane. The amount of any branching agents to be used is 0.05 mol % to 2 mol %, based in turn on moles of diphenols used in each case. All of these measures for producing polycarbonates are familiar to those skilled in the art. Preferred modes of production of the polycarbonates to be used according to the invention, including the polyester carbonates, are the known interfacial process and the known melt transesterification process (cf, e.g. WO 2004/063249 A1, WO 2001/05866 A1, WO 2000/105867, U.S. Pat. Nos. 5,340,905 A, 5,097,002 A, 5,717,057 A). It is preferable when the polycarbonate is produced by the melt transesterification process

In the former case the acid derivatives used are preferably phosgene and optionally dicarbonyl dichlorides and in the latter case preferably diphenyl carbonate and optionally dicarboxylic diesters. Catalysts, solvents, workup, reaction conditions etc. for polycarbonate production or polyestercarbonate production are sufficiently well described and known in both cases. The relative solution viscosity (ηᵣₑₗ) of the aromatic polycarbonates is preferably in the range 1.18 to 1.4, particularly preferably in the range 1.20 to 1.32, very particularly preferably in the range from 1.22 to 1.29 (measured on solutions of 0.5 g of polycarbonate in 100 ml of methylene chloride solution at 25° C.). The weight-average molecular weight Mw of the aromatic polycarbonates and polyestercarbonates is preferably in the range from 15 000 to 35 000, more preferably in the range from 20 000 to 33 000, particularly preferably 23 000 to 30 000. The values for Mw are determined by gel permeation chromatography calibrated against bisphenol A polycarbonate standards using dichloromethane as eluent, calibration with linear polycarbonates (composed of bisphenol A and phosgene) of known molar mass distribution from PSS Polymer Standards Service GmbH. Germany; calibration according to process 2301-0257502-09D (2009 Edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. detection with a refractive index detector (RI).

According to the invention the aromatic polycarbonate of component A has a phenolic OH content of 230 ppm to 1500 ppm, preferably of 260 ppm to 1300 ppm, particularly preferably of 300 ppm to 1000 ppm, likewise preferably of 310 ppm to 800 ppm and very particularly preferably of 350 ppm to 790 ppm. It is likewise preferable when the aromatic polycarbonate of component A has a phenolic OH content of 240 ppm to 1400 ppm, preferably of 300 ppm to 1300 ppm, particularly preferably of 400 ppm to 1200 ppm, likewise preferably of 500 ppm to 1100 ppm and very particularly preferably of 350 ppm to 1050 ppm.

A person skilled in the art is aware of how to determine the phenolic OH content of aromatic polycarbonates. Suitable methods include those of ¹H-NMR-spectroscopy or else infrared techniques. It is preferable to determine the phenolic OH content by ¹-H-NMR spectroscopy. If the aromatic polycarbonate is for example polycarbonate based on bisphenol A the content of OH end groups is determined by ¹H-NMR spectroscopy with dichloromethane solvent at room temperature by evaluating the ratio of the integrals of the signals at 6.68 ppm (two aromatic protons ortho to phenolic OH groups) and at 1.68 ppm (six methyl protons of the bisphenol A unit) ermittelt. If a (co)polycarbonate based on a different bisphenol/comprising further comonomers distinct from bisphenol A is used, a person skilled in the art is capable of determining the phenolic OH content.

Unless otherwise stated the reported ppm values are based on weight.

A person skilled in the art is aware in principle of how to be able to adjust/influence the phenolic OH content of a polycarbonate. If the phase interface process is used a person skilled in the art can adjust the concentration of phenolic OH desired according to the invention for example via the concentration of the chain terminator or the use of special chain terminators, which optionally also contain phenolic OH groups, or else a subsequent reaction of the end groups with compounds containing phenolic OH groups. If the melt transesterification process to produce the polycarbonate is used, a person skilled in the art is aware that the employed catalyst or the ratio of diaryl carbonate to the employed bisphenol can influence the phenolic OH content. Here too, it is possible that in a downstream step the polycarbonate present at the end groups can be modified such that phenolic OH groups are specifically introduced or reacted.

The process according to the invention is especially characterized in that the aromatic polycarbonate of component A) comprises one, particularly preferably two or more of the following structures (4) to (7):

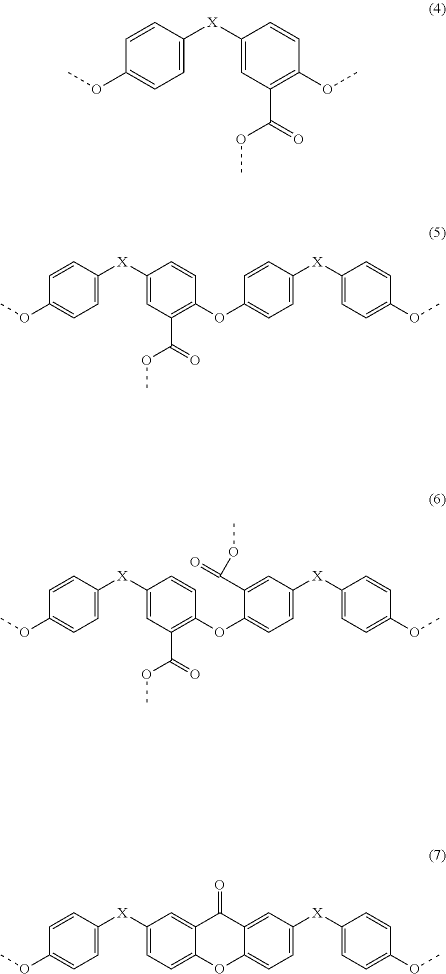

in which the phenyl rings may independently be mono- or disubstituted with C₁- to C₈-alkyl, halogen, preferably C₁- to C₄-alkyl, particularly preferably with methyl, and X represents a single bond, a linear or branched C₁- to C₆-alkylene group, a C₂- to C₁₀-alkylidene group or a C₅- to C₁₀-cycloalkylidene group, preferably represents a single bond or C₁- to C₄-alkylene and especially preferably isopropylidene and the “- - -” represent the bonding of the structures (4) to (7) into the aromatic polycarbonate. It is especially preferable when the amount of structural units (4) to (7) sums to 10 ppm to 1000 ppm, preferably 50 to 950 ppm, particularly preferably 80 ppm to 850 ppm.

To determine the amount of structural units (4) to (7) the respective polycarbonate is subjected to a total hydrolysis and the amount of decomposition products determined with quantitative HPLC. The decomposition products may comprise the structures (4a) to (7a). The structures (4a) to (7a) are reported by way of example for the use of a polycarbonate comprising bisphenol A. (This can be accomplished for example as follows: The polycarbonate sample is hydrolysed under reflux by means of sodium methoxide. The corresponding solution is acidified and concentrated to dryness. The drying residue is dissolved in acetonitrile and the phenolic compounds of the formula (4a) to (7a) are determined by means of HPLC with UV detection):

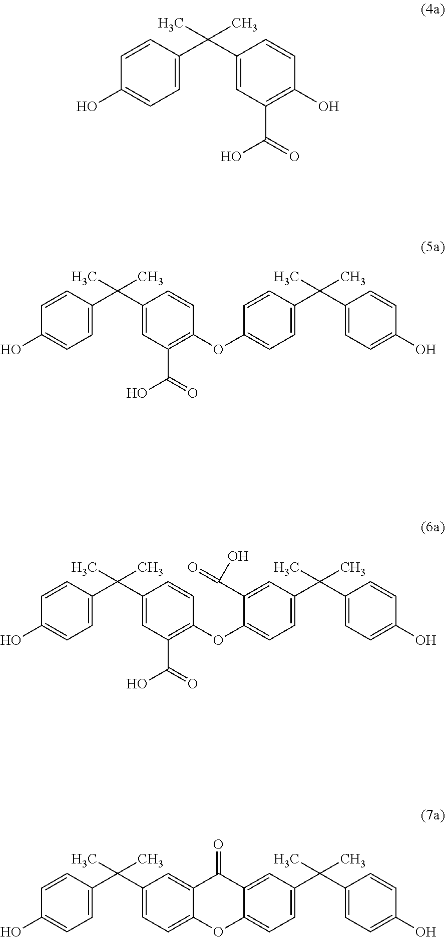 [SMILES: CC(C)(c1ccc(O)cc1)c1ccc(O)c(C(=O)O)c1 ; CC(C)(c1ccc(O)cc1)c1ccc(Oc2ccc(C(C)(C)c3ccc(O)cc3)cc2C(=O)O)cc1 ; CC(C)(c1ccc(O)cc1)c1ccc(Oc2ccc(C(C)(C)c3ccc(O)cc3)cc2C(=O)O)c(C(=O)O)c1 ; CC(C)(c1ccc(O)cc1)c1ccc2oc3ccc(C(C)(C)c4ccc(O)cc4)cc3c(=O)c2c1]

The amount of the thus-liberated compound of formula (4a) is 10 to 800 ppm, preferably 20 to 75 000 ppm, particularly preferably 25 to 700 ppm and especially preferably 30 to 500 ppm.

The amount of the thus-liberated compound of formula (5a) is preferably 0 (i.e. below the detection limit of 10 ppm) to 100 ppm, particularly preferably 0 to 80 ppm and especially preferably 0 to 50 ppm.

The amount of the thus-liberated compound of formula (6a) is preferably 0 (i.e. below the detection limit of 10 ppm) to 800 ppm, more preferably 10 to 700 ppm, particularly preferably 20 to 600 ppm and very particularly preferably 30 to 350 ppm.

The amount of the thus-liberated compound of formula (7a) is preferably 0 (i.e. below the detection limit of 10 ppm) to 300 ppm, preferably 5 to 250 ppm and especially preferably 10 to 200 ppm.

### Component B

The composition may comprise polymer additives as component B. Contemplated polymer additives especially include commercially available polymer additives. Preferred polymer additives according to component B are flame retardants, flame retardant synergists, smoke-inhibiting additives, anti-drip agents, internal and external lubricants and demolding agents, flowability aids, antistats, conductivity additives, nucleating agents, stabilizers, antibacterial additives, scratch resistance-improving additives. IR absorbers, optical brighteners, fluorescent additives, fillers and reinforcers, dyes and pigments and Bronsted-acidic compounds. Especially preferred polymer additives considered are those including flame retardants (for example phosphorus compounds such as phosphoric or phosphonic acid esters, phosphonatamines and phosphazenes or halogen compounds), flame retardant synergists (for example nanoscale metal oxides), smoke-inhibiting additives (for example boric acid or borates), anti-drip agents (for example compounds from the substance classes of the fluorinated polyolefins, the silicones and aramid fibers), internal and external lubricants and demolding agents (for example pentaerythritol tetrastearate, stearyl stearate, montan wax or polyethylene wax), flowability aids (for example low molecular weight vinyl(co)polymers), antistats (for example block copolymers of ethylene oxide and propylene oxide, other polyethers or polyhydroxy ethers, polyetheramides, polyesteramides or sulfonic salts), conductivity additives (for example conductive carbon black or carbon nanotubes), nucleating agents, stabilizers (for example UV/light stabilizers, thermal stabilizers, antioxidants, transesterification inhibitors, hydrolysis stabilizers), antibacterial additives (for example silver or silver salts), scratch resistance-improving additives (for example silicone oils or hard fillers such as (hollow) ceramic beads). IR absorbers, optical brighteners, fluorescent additives, fillers and reinforcers (for example talc, optionally ground glass or carbon fibers. (hollow) glass or ceramic beads, mica, kaolin. CaCO₃ and glass flakes) and dyes and pigments (for example carbon black, titanium dioxide or iron oxide), impact modifiers and Bronsted-acidic compounds as base scavengers or else mixtures of a plurality of the aforementioned additives.

According to the invention the weight percentages specified in respect of the thermoplastic composition are to be understood as being based on the total weight of the thermoplastic composition. The thermoplastic composition preferably comprises at least 95.0% by weight of component A) and >0% by weight to 5.0% by weight of component B), particularly preferably at least 95.0% by weight of component A) and 0.01 to 5.0% by weight of component B), very particularly preferably at least 96.0% by weight of component A) and 0.05% by weight to 4.0% by weight of component B). It is preferable when the thermoplastic composition is substantially composed of components A) and B). It is very particularly preferable when the thermoplastic composition is composed of components A) and B).

It is preferable when at least one heat stabilizer is employed in the thermoplastic composition as component B). Suitable thermal stabilizers are in particular phosphorus-based stabilizers selected from the group of the phosphates, phosphites, phosphonites, phosphines and mixtures thereof. Examples include trisisooctyl phosphate, triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite (Irgafos 168), diisodecyl pentaerythritol diphosphite, bis(2,4-di-tert-butylphenyl)pentaerythritol diphosphite, bis(2,4-dicumylphenyl)pentaerythritol diphosphite (Doverphos S-9228), bis(2,6-di-tert-butyl-4-methylphenyl)pentaerythritol diphosphite, diisodecyloxy pentacrythritol diphosphite, bis(2,4-di-tert-butyl-6-methylphenyl)pentaerythritol diphosphite, bis(2,4,6-tris(tert-butylphenyl) pentaerythritol diphosphite, tristearyl sorbitol triphosphite, tetrakis(2,4-di-tert-butylphenyl)-4,4′-biphenylenediphosphonite, 6-isooctyloxy-2,4,8,10-tetra-tert-butyl-12H-dibenzo[d,g]-1,3,2-dioxaphosphocine, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyldibenzo[d,g]-1,3,2-dioxaphosphocine, 2,2′,2″-nitrilo[triethyltris(3,3′,5,5′-tetra-tert-butyl-1,1′-biphenyl-2,2′-diyl) phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, bis(2,6-di-tert-butyl-4-methylphenyl)pentaerythritol diphosphite, triphenylphosphine (TPP), trialkylphenylphosphine, bisdiphenylphosphinoethane or a trinaphthylphosphine. They are used alone or in admixture, e.g. Irganox B900 (mixture of Irgafos 168 and Irganox 1076 in a 4:1 ratio) or Doverphos S-9228 with Irganox B900 or Irganox 1076. It is especially preferable to employ triphenylphosphine (TPP), trisisooctylphsophate. Irgafos 168 or tris(nonylphenyl) phosphite, or mixtures thereof. The heat stabilizers are preferably used in amounts of up to 1.0% by weight, more preferably 0.003% by weight to 1.0% by weight, more preferably still 0.005% by weight to 0.5% by weight, particularly preferably 0.01% by weight to 0.2% by weight. It is especially preferable when TPP is employed in amounts of 0% to 0.1% by weight, particularly preferably 0.05% to 0.08% by weight and very particularly preferably 0.01% to 0.05% by weight. It is likewise preferable when stabilizers from the group of phosphites are employed in amounts of 0.01% to 0.1% by weight, particularly preferably 0.015% to 0.09% by weight and particularly preferably 0.02% to 0.08% by weight.

Also employable are phenolic antioxidants such as alkylated monophenols, alkylated thioalkylphenols, hydroquinones and alkylated hydroquinones. It is particularly preferable to employ Irganox 1010 (pentaerythritol-3-(4-hydroxy-3,5-di-tert-butylphenyl) propionate; CAS: 6683-19-8) and Irganox 1076 (octadecyl-3-(3,5-di-tert-butyl-4-hydroxyphenyl) propionate). These are preferably employed in amounts of 0.001%-0.5% by weight, particularly preferably 0.0025% to 0.1% by weight and very particularly preferably 0.005% to 0.04% by weight.

Particularly suitable ultraviolet absorbers are hydroxy benzotriazoles, such as 2-(3′,5′-bis(1,1-dimethylbenzyl)-2′-hydroxy phenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), bis(3-(2H-benzotriazolyl)-2-hydroxy-5-tert-octyl)methane (Tinuvin® 360, BASF SE, Ludwigshafen), 2-(4,6-diphenyl-1,3,5-triazin-2-yl)-5-(hexyloxy)phenol (Tinuvin® 1577, BASF SE, Ludwigshafen), 2-(5-chloro-2H-benzotriazol-2-yl)-6-(1,1-dimethylethyl)-4-methylphenol (Tinuvin® 326, BASF SE, Ludwigshafen), and also benzophenones such as 2,4-dihydroxy benzophenone (Chimassorb® 22, BASF SE, Ludwigshafen) and 2-hydroxy-4-(octyloxy)benzophenone (Chimassorb® 81, BASF SE, Ludwigshafen), 2,2-bis[[(2-cyano-1-oxo-3,3-diphenyl-2-propenyl)oxy]methyl]-1,3-propanediyl ester (9CI) (Uvinul 3030, BASF SE Ludwigshafen), 2-[2-hydroxy-4-(2-ethylhexyl)oxy]phenyl-4,6-di(4-phenyl)phenyl-1,3,5-triazine (Tinuvin® 1600, BASF SE, Ludwigshafen), tetraethyl 2,2′-(1,4-phenylenedimethylidene)bismalonate (Hostavin B-Cap, Clariant AG) or N-(2-ethoxyphenyl)-N′-(2-ethylphenyl)ethanediamide (Tinuvin® 312, CAS no, 23949-66-8, BASF SE, Ludwigshafen).

If UV absorbers are present, the composition preferably contains ultraviolet absorbers in an amount of up to 0.8% by weight, preferably 0.05% by weight to 0.5% by weight, more preferably 0.08% by weight to 0.4% by weight, very particularly preferably 0.1% by weight to 0.35% by weight, based on the overall composition.

Suitable demolding agents especially include pentaerythritol tetrastearate (PETS) and glycerol monostearate (GMS). If demolding agents are present the composition preferably contains up to 0.8% by weight, preferably 0.05% by weight to 0.5% by weight, more preferably 0.08% by weight to 0.4% by weight, very particularly preferably 0.1% by weight to 0.35% by weight, based on the total composition.

It has especially proven advantageous when the thermoplastic composition comprises as component B) at any rate at least one hydroxyl component (I) comprising at least three carbon atoms and at least three hydroxyl groups, wherein at least one of these at least three hydroxyl groups is in each case esterified with an aliphatic saturated or unsaturated linear, cyclic or branched C₁-C₃₂-carboxylic acid or benzoic acid and at least one of these at least three hydroxyl groups is in the form of a free hydroxyl group. It goes without saying that other components B) may also be present in this case.

It has surprisingly been found that the additional use of special hydroxyl components in the carrier material has the result that the improved composite adhesion is yet further improved. However, the special hydroxyl component accumulates predominantly at the surface of the carrier. This has the result that the bulk properties of the carrier are hardly influenced by the use of the additional additive. The composite shows a further improvement especially relative to a comparable system but the polycarbonate of component A) comprises no additive having at least one hydroxyl group, preferably no special hydroxyl component (I). Without wishing to be bound to theory it is assumed that the special hydroxyl component (I) can act as an adhesion promoter on account of its chemical nature. The hydrophilic OH groups and optionally, if present, also the hydrophobic hydrocarbon chains (especially when they are long-chain) have the result that they accumulate at the surface of the carrier during formation of the carrier and/or after formation of the carrier. Simultaneously the hydrophobic hydrocarbon groups result in a secure anchoring in and on the carrier material (in particular long-chain hydrocarbons can entangle with the carrier material in a manner known to a person skilled in the art and thus form a stressable bond even without formation of a covalent bond). The mobility and thus the tendency for surface accumulation can be influenced here in terms of the carrier via the cooling process, for example. The warmer the melt remains, the more mobile the molecules. The temperature of the melt may be influenced for example by increasing the overall melt temperature in the process or the mold temperature. This surface accumulation simultaneously has the effect that the special hydroxyl component is depleted in the bulk of the carrier material. This has the result that the hydroxyl component hardly influences the bulk properties of the carrier. However, this also secondly has the effect that the amount of the hydroxyl component can be minimized since it is efficiently utilized only where it is also needed. This additionally reduces the costs.

Without wishing to be tied to theory it is assumed that especially the further additional OH groups present at the surface of the carrier formed are available for reaction with the components of the polyurethane raw material mixture. The combination of covalent bonds between the polycarbonate and the polyurethane and the bonds between the reacted hydroxyl compound and the polyurethane which are securely anchored in the carrier material but are nevertheless more flexible altogether result in good bonding.

The hydroxyl component (I) is preferably represented by structural formula (I)

(R₄—C(═O)O)ₒ—(R₅)ₓ—(OH)ₚ (I),
in which
each R₄ is independently an aliphatic saturated or unsaturated, linear, cyclic or branched C₁-C₃₁-alkyl radical or phenyl.

R₅ is a linear, cyclic or branched alkylene group having x carbon atoms, wherein x is 3 to 12, preferably 3 to 8, particularly preferably 3 to 7, very particularly preferably 3 to 5, and each of these carbon atoms present in R₅ may each comprise the substituents (R₄—C(═O)O)ₒ—, —(OH)ₚ and/or hydrogen or an alkyl radical and
is a number from 1 to 12 and p is a number from 1 to 12 with the proviso that o+p is 2 to 12 and the maximum of o+p is determined by the maximum number x of the carbon atoms in R₅.

It is apparent to a person skilled in the art that formula (I) has only as many substituents as the carbon has valences. If a branched R₅-alkylene group comprises for example at least one tertiary carbon this tertiary carbon atom thus has only at most one valence remaining for one of the substituents R₄—C(═O)O)ₒ—, —(OH)ₚ and/or hydrogen. A branched R₅-alkylene group may likewise comprise a quaternary carbon atom which has no valence for a further substituent.

It is likewise preferable when the hydroxyl component (I) is represented by structural formula (Ia) or (Ib)

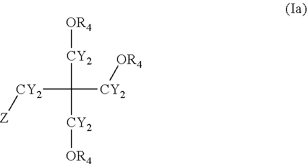

in which each R₄ is independently hydrogen, an aliphatic saturated or unsaturated, linear, cyclic or branched C₁-C₃₁-alkyl radical or phenyl under the conditions that at least one Ra is hydrogen and at least one R₄ is an aliphatic saturated or unsaturated, linear, cyclic or branched C₁-C₃₁-alkyl radical or phenyl.
each Y independently represents hydrogen, an alkyl or aryl radical and
Z represents hydrogen, an alkyl radical or OR₄,

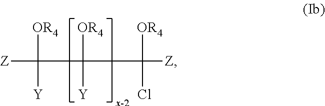

in which each R₄ is independently hydrogen, an aliphatic saturated or unsaturated, linear, cyclic or branched C₁-C₃₁-alkyl radical or phenyl under the conditions that at least one R₄ is hydrogen and at least one R₄ is an aliphatic saturated or unsaturated, linear, cyclic or branched C₁-C₃₁-alkyl radical or phenyl,
each Y independently represents hydrogen, an alkyl or aryl radical,
Z represents hydrogen or an alkyl radical and
x is a number between 3 to 12, preferably 3 to 8, particularly preferably 3 to 7, very particularly preferably 3 to 5.

It is especially preferable when x in structural formula (I) or (Ib) represents 3 to 5.

It is especially preferable when each R₄ in structural formula (I), (Ia) or (Ib) is independently methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, 1-ethyl-2-methylpropyl, n-heptyl, n-octyl, pinacyl, adamantyl, the isomeric menthyls, n-nonyl, n-decyl, n-dodecyl, n-tridecyl, n-tetradecyl, n-hexadecyl or n-octadecyl. It is particularly preferable when each R₄ in structural formula (I), (Ia) or (Ib) independently represents n-nonyl, n-decyl, n-dodecyl, n-tridecyl, n-tetradecyl, n-hexadecyl or n-octadecyl.

It is likewise preferable, especially preferably in combination with the above-described definitions for R₄, when each Y in structural formula (I), (Ia) or (Ib) independently represents hydrogen, methyl, ethyl, propyl, butyl or phenyl. Component B) is particularly preferably glycerol monostearate.

The thermoplastic composition preferably comprises 0.0001% to 5% by weight, particularly preferably 0.001% to 1% by weight, very particularly preferably 0.01% to 0.8% by weight and most preferably 0.02% to 0.06% by weight of hydroxyl component (I). These amounts ensure that the effect of improved composite adhesion occurs while at the same time the amount is sufficiently low that the bulk properties of the carrier are hardly altered.

It is particularly preferable when component B) comprises at least one stabilizer, preferably from the group of phosphites and/or phosphates, particularly preferably one of the aforementioned compounds, at least one demolding agent, at least one UV absorber, at least one phenolic antioxidant and optionally dyes (organic) and/or pigments (organic and inorganic).

It is very particularly preferable when component B) comprises TPP in amounts of 0% to 0.1% by weight, particularly preferably 0.05% to 0.08% by weight and very particularly preferably 0.01% to 0.05% by weight of at least one stabilizer from the group of phosphites and/or phosphates in amounts of 0.01% to 0.1% by weight, particularly preferably 0.015% to 0.09% by weight and particularly preferably 0.02% to 0.08% by weight, of at least one ultraviolet absorber in an amount up to 0.8% by weight, preferably 0.05% by weight to 0.5% by weight, more preferably 0.08% by weight to 0.4% by weight, very particularly preferably 0.1% by weight to 0.35% by weight, at least one demolding agent up to 0.8% by weight, preferably 0.05% by weight to 0.5% by weight, more preferably 0.08% by weight to 0.4% by weight, very particularly preferably 0.1% by weight to 0.35% by weight.

### Further Thermoplastic Composition (Z2) According to Process Step (Ib)

In process step (ib) the film is overmolded with a further thermoplastic composition (Z2), wherein the further thermoplastic composition (Z2) can be the same as or different from the thermoplastic composition (Z). The further thermoplastic composition (Z2) may comprise the above-described components A) and B) in all preferences and/or combinations. However, the material of the thermoplastic composition (Z2) is not limited and may be adapted and selected based on the properties demanded by the intended use provided this composition is thermoplastic. It is apparent to a person skilled in the art that the adhesion between this further thermoplastic composition (Z2) and the film is also very important and may be optimized. This is within the knowledge and ability of a person skilled in the art.

### Polyurethanes

The coating employed is preferably a polyurethane foam or a compact polyurethane layer.

The polyurethanes employed according to the invention are obtained by reacting polyisocyanates with H-active polyfunctional compounds, preferably polyols.

In the context of the present invention the term “polyurethane” is to be understood as also meaning polyurethane ureas in which compounds having NH functionality, optionally in admixture with polyols, are employed as H-active polyfunctional compounds.

Suitable polyisocyanates are the aromatic, araliphatic, aliphatic or cycloaliphatic polyisocyanates which have an NCO functionality of preferably ≥2, are known per se to a person skilled in the art and which may also comprise iminooxadiazinedione, isocyanurate, uretdione, urethane, allophanate, biuret, urea, oxadiazinetrione, oxazolidinone, acylurea and/or carbodiimide structures. These may be employed individually or in any desired mixtures with one another.

The abovementioned polyisocyanates are based on di- and/or triisocyanates known per se to the skilled person and having aliphatically, cycloaliphatically, araliphatically and/or aromatically bonded isocyanate groups, it being immaterial whether they were produced using phosgene or by phosgene-free processes. Examples of such di- or triisocyanates are 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)-cyclohexane, 1-isocyanato-3,3,5-trimethyl-5-isocyanatomethylcyclohexane (isophorone diisocyanate, IPDI), 4,4′-diisocyanatodicyclohexylmethane (Desmodur® W, Covestro AG, Leverkusen, DE), 4-isocyanatomethyl-1,8-octane diisocyanate (triisocyanatononane, TIN), ω,ω′-diisocyanato-1,3-dimethylcyclohexane (H₆XDI), 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3- and 1,4-bis(2-isocyanatoprop-2-yl)benzene (TMXDI), 2,4- and 2,6-diisocyanatotoluene (TDI), in particular the 2,4 and the 2,6 isomers, and technical mixtures of the two isomers, 2,4′- and 4,4′-diisocyanatodiphenylmethane (MDI), polymeric MDI (pMDI), 1,5-diisocyanatonaphthalene, 1,3-bis(isocyanatomethyl)benzene (XDI) and any desired mixtures of the recited compounds.

It is preferable when the polyisocyanates have an average NCO functionality of 2.0 to 5.0, preferably of 2.2 to 4.5, particularly preferably of 2.2 to 2.7, and a content of isocyanate groups of 5.0% to 37.0% by weight, preferably of 14.0% to 34.0% by weight.

In a preferred embodiment polyisocyanates or polyisocyanate mixtures of the abovementioned type having exclusively aliphatically and/or cycloaliphatically bonded isocyanate groups are employed.

It is very particularly preferred when the polyisocyanates of the abovementioned type are based on hexamethylene diisocyanate, isophorone diisocyanate, the isomeric bis(4,4′-isocyanatocyclohexyl)methanes and mixtures thereof.

Of interest among the higher molecular weight, modified polyisocyanates are in particular the terminal isocyanate-containing prepolymers in the molecular weight range 400 to 15 000, preferably 600 to 12 000, which are known from polyurethane chemistry. These compounds are produced in a manner known per se by reaction of excess amounts of simple polyisocyanates of the type recited by way of example with organic compounds having at least two isocyanate-reactive groups, in particular organic polyhydroxyl compounds. Suitable polyhydroxyl compounds of this type include not only simple polyhydric alcohols in the molecular weight range 82 to 599, preferably 62 to 200, for example ethylene glycol, trimethylolpropane, 1,2-propanediol or 1,4-butanediol or 2,3-butanediol, but in particular higher molecular weight polyether polyols and/or polyester polyols of the type known per se from polyurethane chemistry having molecular weights of 600 to 12 000, preferably 800 to 4000, and having at least two, generally 2 to 8, but preferably 2 to 6, primary and/or secondary hydroxyl groups. It will be appreciated that it is also possible to employ NCO prepolymers produced for example from low molecular weight polyisocyanates of the type recited by way of example and less preferred compounds having isocyanate-reactive groups such as for example polythioether polyols, hydroxyl-containing polyacetals, polyhydroxypolycarbonates, hydroxyl-containing polyesteramides or hydroxyl-containing copolymers of olefinically unsaturated compounds.

Compounds having isocyanate-reactive groups, in particular hydroxyl groups, suitable for producing the NCO prepolymers are, for example, the compounds disclosed in U.S. Pat. No. 4,218,543. During production of the NCO prepolymers these compounds having isocyanate-reactive groups are reacted with simple polyisocyanates of the type exemplarily recited above while maintaining an NCO excess. The NCO prepolymers generally have an NCO content of 10% to 26% by weight, preferably 15% to 26% by weight. It is apparent from the above that in the context of the present invention the terms “NCO prepolymers” and “prepolymers having terminal isocyanate groups” are to be understood as meaning both the reaction products as such and also the mixtures with excess amounts of unconverted starting polyisocyanates often also known as “semiprepolymers”.

Contemplated aliphatic diols having an OH number of >500 mg KOH/g include the chain extenders customarily used in crosslinking in polyurethane chemistry, such as ethylene glycol, diethylene glycol, propylene glycol, dipropylene glycol, 1,4-butanediol, 1,3-propanediol, Diols such as 2-1,4-butanediol, 1,3-butanediol, 2,3-butanediol and/or 2-methyl-1,3-propanediol are preferred. It will be appreciated that it is also possible to employ the aliphatic diols in admixture with one another. Suitable H-active components include polyols having an average OH number of 5 to 600 mg KOH/g and an average functionality of 2 to 6. Polyols having an average OH number of 10 to 50 mg KOH/g are preferred. Polyols suitable according to the invention include for example polyhydroxypolyethers obtainable by alkoxylation of suitable starter molecules such as ethylene glycol, diethylene glycol. 1,4-dihydroxy butane, 1,6-dihydroxyhexane, dimethylolpropane, glycerol, pentaerythritol, sorbitol or sucrose. Likewise suitable as starters are ammonia or amines such as ethylenediamine, hexamethylenediamine, 2,4-diaminotoluene, aniline or amino alcohols or phenols such as bisphenol A. The alkoxylation is carried out in any desired sequence using propylene oxide and/or ethylene oxide or as a mixture.

Additionally employable in addition to polyols is at least one further crosslinker and/or chain extender selected from the group containing amines and amino alcohols, for example ethanolamine, diethanolamine, diisopropanolamine, ethylenediamine, triethanolamine, isophoronediamine, N,N′-dimethyl(diethyl)ethylenediamine, 2-amino-2-methyl (or ethyl)-1-propanol, 2-amino-1-butanol, 3-amino-1,2-propanediol, 2-amino-2-methyl (ethyl)-1,3-propanediol, and alcohols, for example ethylene glycol, diethylene glycol, 1,4-dihydroxybutane, 1,6-dihydroxy hexane, dimethylolpropane, glycerol and pentaerythritol, and also sorbitol and sucrose or mixtures of these compounds.

Also suitable are polyester polyols such as are obtainable by reaction of low molecular weight alcohols with polybasic carboxylic acids such as adipic acid, phthalic acid, hexahydrophthalic acid, tetrahydrophthalic acid or the anhydrides of these acids in a manner known per se provided that the viscosity of the H-active component does not become excessively large. A preferred polyol comprising ester groups is ricinoleic acid. Preparations comprising castor oil such as are obtainable by dissolution of resins, for example of aldehyde-ketone resins, and also modifications of castor oil and polyols based on other natural oils are also suitable.

Likewise suitable are higher molecular weight polyhydroxy polyethers in which high molecular weight polyadducts or polycondensates or polymers are present in finely dispersed, dissolved or grafted form. Such modified polyhydroxyl compounds are obtained in a manner known per se, for example when polyaddition reactions (for example reactions between polyisocyanates and amino-functional compounds) or polycondensation reactions (for example between formaldehyde and phenols and/or amines) are allowed to take place in situ in the hydroxyl-containing compounds. However, it is also possible to mix a ready-to-use aqueous polymer dispersion with a polyhydroxyl compound and then remove the water from the mixture.

Polyhydroxyl compounds modified by vinyl polymers such as are obtained for example by polymerization of styrene and acrylonitrile in the presence of polyethers or polycarbonate polyols are also suitable for the production of polyurethanes. Using polyether polyols modified according to DE-A 2 442 101, DE-A 2 844 922 and DE-A 2 646 141 by graft polymerization with vinylphosphonic esters and optionally (meth)acrylonitrile, (meth)acrylamide or OH-functional (meth)acrylic acid esters affords plastics of particular flame retardancy.

Representatives of the recited compounds to be used as H-active compounds are described, for example, in High Polymers, vol. XVI, “Polyurethanes Chemistry and Technology”, Saunders-Frisch (ed.) Interscience Publishers, New York, London, vol. 1, pp. 32-42, 44, 54 and vol. II, 1984, pp. 5-6 and pp. 198-199.

It is also possible to employ mixtures of the recited compounds.

The limitation to the average OH number and average functionality of the H-active component results in particular from the increasing embrittlement of the resulting polyurethane. However, those skilled in the art are in principle aware of the possibilities of influencing the polymer physics properties of polyurethane, and the NCO component, aliphatic diol and polyol can therefore be favorably adapted to one another.

The polyurethane layer (b) may be foamed or solid, for example in the form of a lacquer or coating.

All auxiliaries and additives known per se such as, for example, release agents, blowing agents, fillers, catalysts and flame retardants, may be used for the production thereof.

Optionally employable as auxiliaries and additives are:

a) Water and/or Volatile Inorganic or Organic Substances as Blowing Agents

Suitable organic blowing agents include for example acetone, ethyl acetate, halogen-substituted alkanes such as methylene chloride, chloroform, ethylidene chloride, vinylidene chloride, monofluorotrichloromethane, chlorodifluoromethane, dichlorodifluoromethane, also butane, hexane, heptane or diethyl ether, and suitable inorganic blowing agents include air, CO₂ or N₂O. A blowing effect can also be achieved by addition of compounds which decompose with elimination of gases, for example of nitrogen, at temperatures above room temperature, for example azo compounds such as azodicarbonamide or azoisobutyronitrile.

### b) Catalysts

The catalysts are, for example,
tertiary amines (such as triethylamine, tributylamine, N-methylmorpholine, N-ethylmorpholine, N,N,N′,N′-tetramethylethylenediamine, pentamethyldiethylenetriamine and higher homologs, 1,4-diazabicyclo-(2,2,2)octane, N-Methyl-N′-dimethylaminoethylpiperazine, bis(dimethyl-aminoalkyl)piperazines, N,N-dimethylbenzylamine, N,N-dimethylcyclohexylamine, N,N-diethylbenzy lamine, bis(N,N-diethy laminoethyl) adipate, N,N,N′,N′-tetramethyl-1,3-butanediamine, N,N-dimethyl-β-phenylethylamine, 1,2-dimethylimidazole, 2-methylimidazole),
monocyclic and bicyclic amides, bis(dialkylamino)alkyl ethers,
tertiary amines comprising amide groups (preferably formamide groups),
Mannich bases composed of secondary amines (such as dimethylamine) and aldehydes (preferably formaldehyde or ketones such as acetone, methyl ethyl ketone or cyclohexanone) and phenols (such as phenol, nonylphenol or bisphenol),
tertiary amines comprising isocyanate-active hydrogen atoms (for example triethanolamine, triisopropanolamine, N-methyldiethanolamine, N-ethyldiethanolamine, N,N-dimethyl-ethanolamine) and their reaction products with alkylene oxides such as propylene oxide and/or ethylene oxide,
secondary/tertiary amines,
silaamines with carbon-silicon bonds (2,2,4-trimethyl-2-silamorpholine and 1,3-diethylaminomethyltetramethyldisiloxane),
nitrogen-containing bases (such as tetraalkylammonium hydroxides),
alkali metal hydroxides (such as sodium hydroxide, alkali metal phenoxides such as sodium phenoxide),
alkali metal alkoxides (such as sodium methoxide) and/or
hexahydrotriazines.

The reaction between NCO groups and Zerewitinoff-active hydrogen atoms is also greatly accelerated in a manner known per se by lactams and azalactams by initially forming an adduct between the lactam and the compound comprising acidic hydrogen.

Also employable as catalysts are organic metal compounds, in particular organic tin and/or bismuth compounds. Preferably contemplated as organic tin compounds in addition to sulfur-containing compounds such as di-n-octyl tin mercaptide are tin(II) salts of carboxylic acids such as tin(II) acetate, tin(II) octoate, tin(II) ethylhexoate and tin(II) laurate and the tin(IV) compounds, for example dibutyltin oxide, dibutyltin dichloride, dibutyltin diacetate, dibutyltin dilaurate, dibutyltin maleate or dioctyltin diacetate. Organic bismuth catalysts are described in patent application WO 2004/000905 for example.

It will be appreciated that all of the abovementioned catalysts may be employed as mixtures. Combinations of organic metal compounds and amidines, aminopyridines or hydrazinopyridines are of particular interest.

The catalysts are generally used in an amount of about 0.001% to 10% by weight based on the total amount of compounds having at least two isocyanate-reactive hydrogen atoms.

### c) Surface-Active Additives Such as Emulsifiers and Foam Stabilizers.

Suitable emulsifiers are for example the sodium salts of castor oil sulfonates or salts of fatty acids with amines such as diethylamine oleate or diethanolamine stearate. Alkali metal or ammonium salts of sulfonic acids such as for instance of dodecylbenzenesulfonic acid or dinaphthylmethanedisulfonic acid or of fatty acids such as ricinoleic acid or of polymeric fatty acids can also be used as surface-active additives.

Suitable foam stabilizers particularly include polyethersiloxanes, especially water-soluble representatives. The construction of these compounds is generally such that a copolymer of ethylene oxide and propylene oxide is attached to a polydimethylsiloxane radical. Of particular interest are polysiloxane-polyoxyalkylene copolymers multiply branched via allophanate groups.

### d) Reaction Retarders

Suitable reaction retarders are for example acidic substances (such as hydrochloric acid or organic acid halides).

### e) Additives

Contemplated PU additives are for example cell regulators of the type known per se (such as paraffins or fatty alcohols) or dimethylpolysiloxanes and pigments or dyes and flame retardants of the type known per se (for example trischloroethyl phosphate, tricresyl phosphate or ammonium phosphate and polyphosphate), also stabilizers against aging and weathering influences, plasticizers and fungistatic and bacteriostatic substances and fillers (such as barium sulfate, diatomaceous earth, carbon black or precipitated chalk).

Further examples of surface-active additives and foam stabilizers and cell regulators, reaction retarders, stabilizers, flame retardants, plasticizers, dyes and fillers and fungistatic and bacteriostatic substances for optional co-use according to the invention are known to a person skilled in the art and described in the literature.

According to the invention it is preferable when a low-solvent reactive polyurethane raw material mixture having a solvent content of at most 10% by weight, preferably at most 2% by weight, particularly preferably at most 1% by weight, based on the lacquer proportion, is used. It is likewise preferable when a solvent-free reactive polyurethane raw material mixture is used. The presence of a solvent can cause bubble formation. It also increases the VOC content (volatile organic compounds) in production. Especially for use in the IMC process and/or RIM process, it is advantageous to use low-solvent to solvent-free polyurethane raw material mixtures since in these processes the solvent cannot evaporate in the short reaction time and/or the mold is closed.

It is customary to employ lacquer systems having a short pot life. It is preferable to select systems having a pot life of at most 1 min, particularly preferably having a pot life of at most 30 s, very particularly preferably having a pot life of at most 10 s. It is preferable to adapt the cycle time for reaction of the lacquer system to the injection molding cycle time. This is particularly economic. For short pot lives it is preferable to use a high-pressure countercurrent mixing head to mix the two components. Compared to other processes this allows for the highest productivity. In addition no residues of mixed lacquer raw materials remain in the mold at the end of the process.

A further aspect of the present invention provides a composite component part comprising
a) a carrier composed of a thermoplastic composition containing
   A) at least 95.0% by weight of an aromatic polycarbonate having a phenolic OH content of 230 ppm to 1500 ppm and
   B) contains 0% to 5.0% by weight of at least one commercially available polymer additive,
b) at least one polyurethane layer in direct contact with the carrier,
produced in a 2-component reactive injection molding process. This is particularly preferably an IMC process or RIM process. It is very particularly preferably an IMC process.

Preferably concerned here are the above-described components A), B) and the above-described polyurethane layer in all preferences and combinations of preferences. It is likewise preferable when the composite component part according to the invention is obtained by the process according to the invention.

It is preferable when the phenolic OH content of component A) in respect of the composite component part is based on the starting composition. It may be the case that the OH content reduces at least at the surface of the carrier through reaction with the reactive polyurethane raw material mixture. However, this is very likely unverifiable. This is especially because the reaction takes place substantially only at the interface and the polyurethane raw material mixture hardly penetrates into the carrier material. The OH content of the carrier of the finished composite component part may be determined by destruction of the carrier, for example by scraping it off. This may especially be done using the above-described methods, preferably ¹H-NMR. In the case where a film is used it is also possible to employ IR microscopy, thin sections or else polished sections.

It is especially preferable when the composite component part according to the invention is produced in a 2-component reactive injection molding process with a reactive polyurethane raw material mixture containing
at least one polyisocyanate component,
at least one polyfunctional H-active compound and
optionally at least one polyurethane additive and/or processing auxiliary.
wherein the reactive polyurethane raw material mixture has an index of >90 to <140.

It is likewise preferable when the composite component part according to the invention is an interior or exterior component part of a rail vehicle, aircraft or motor vehicle.

A further aspect of the present invention provides for a use of a composition, wherein the composition contains
A) at least 95.0% by weight of an aromatic polycarbonate having a phenolic OH content of 230 ppm to 1500 ppm and
B) 0% to 5.0% by weight of at least one commercially available polymer additive
as a carrier material in the production of a composite component part comprising a carrier and at least one polyurethane layer in direct contact with the carrier in a 2-component reactive injection molding process. Preferably concerned here are the above-described components A). B) and the above-described polyurethane layer in all preferences and combinations of preferences.

### EXAMPLES

### Materials Used:

PC1: Bisphenol A-based linear polycarbonate based on a mixture of 60% by weight of a polycarbonate having a melt volume flow rate MVR of 12 cm³/(10 min) (according to ISO 1133:2012-03 at a test temperature of 300° C. and a load of 1.2 kg) and 40% by weight of a polycarbonate having a melt volume flow rate MVR of 30 cm³/(10 min) (at a test temperature of 250° C. and a load of 1.2 kg)
PC2: Linear polycarbonate based on bisphenol A having a melt volume flow rate MVR of 30 cm³/(10 min) (at a test temperature of 250° C. and a load of 1.2 kg)
PC3: Linear polycarbonate based on bisphenol A having a melt volume flow rate MVR of 12 cm³/(10 min) (according to ISO 1133:2012-03 at a test temperature of 300° C. and a load of 1.2 kg)
PC4: Linear polycarbonate in powder form based on bisphenol A having a melt volume flow rate MVR of 6 cm³/(10 min) (according to ISO 1133:2012-03, at a test temperature of 300° C. and a load of 1.2 kg).
GMS: Glycerol monostearate (CAS 91052-47-0)
Reactive polyurethane raw material mixture: The polyurethane coating systems employed were mixtures of puroclear 3351 IT (polyol component) and puronat 960/1 (diisocyanate component) both from RÜHL PUROMER GmbH. Friedrichsdorf, Germany, having a mixing ratio of 100 to 229, puroclear 3351 IT is a polyol formulation which may be processed with puronate 960/1 (HDI isocyanate component) to afford a lightfast casting elastomer system having a density of 1.09 g/cm³ at 20° C. and a viscosity of about 1000 mPas at 25° C. puronate 960/1 is a liquid, colorless aliphatic polyisocyanate having a density of about 1.13 g/cm³ at 20° C. and a viscosity of about 2500 mPas at 25° C.

### Test Methods Used

Adhesion: Adhesion was determined by means of the “POSI” test according to DIN EN ISO 4624:2016-08. Method B (8.4.2) indicating the most damaged defect pattern was used. In a departure from the standard the median of 3 specimens was formed with 8 measurements in each case. The most common defect pattern was determined and reported in the table. Table 1 states the following:
A: Cohesive failure, substrate, A/B: Adhesive failure, substrate and coating, B: Cohesive failure, coating and Y: Cohesive failure of adhesive.
Hydrolysis storage: The composite component parts were stored in the conditioning cabinet for 72 h at (90±2)° C. and (95±3)% relative humidity. The formation of water droplets on the component part was avoided by suitable positioning in the conditioning cabinet. The component parts were then re-subjected to adhesion testing by means of the “POSI” test (see above).
Phenolic OH content: The content of OH end groups was measured on unlacquered regions of the composite component parts. It was measured by 1H-NMR spectroscopy (600 MHZ) with CDCl₃ as solvent at room temperature by evaluating the ratio of the integrals of the signals at 6.68 ppm (two aromatic protons ortho to phenolic OH groups) and at 1.68 ppm (six methyl protons of the bisphenol A unit).

### Production and Characterization of the Molding Compounds:

The compounds were produced in a ZSK25. The melt temperature was 260° C. and the speed of rotation 225 rpm. The throughputs were between 17.5 and 20 kg/h.

### Production of the Composite Component Parts:

Partially surface-coated injection molded parts having a projected area of 286.4 cm² were produced on an injection molding machine in an injection mold having two cavities (a substrate-side cavity and a polyurethane-side coating cavity linked to an RIM system). The composite component part was a sheetlike component part composed of thermoplastic (carrier), whose surface has been partially coated with a polyurethane skin. The coated area of the component part was 225.5 cm². Of this area. 150 cm² served as the test area for adhesion tests. 8 measurements were performed on the test area. The wall thicknesses of the test area were about 3.2 mm for the injection molded component part and 0.5 mm for the polyurethane layer. In each case three composite component parts were used for the initial adhesion measurement and three composite component parts were used for the adhesion measurement after hydrolysis storage.

In the first process step the carrier was produced. To this end, thermoplastic granulate of the compositions, as described in table 1, was melted in an injection molding barrel and injected into the first mold cavity of the closed mold at a temperature of 300° C. This mold cavity was temperature-controlled to the temperature of 100° C. Once the holding time and the cooling time which led to solidification of the carrier had elapsed, the mold was opened in the second process step. The produced carrier component part was held on the ejector side of the injection mold. The sliding table on the die side of the injection mold was shifted to position two. In the third process step the mold was closed again and the carrier together with the mold formed a cavity for the polyurethane coating.

In the fourth process step the two reactive components of the polyurethane coating system from the RIM system were conveyed into a high-pressure countercurrent mixing head and mixed therein prior to injection. The PU-side cavity was temperature-controlled to temperatures of 100° C. Once the reaction time and the cooling time had elapsed in the fifth process step the mold was opened once more and the coated molded part was demolded.

The molded parts were subsequently subjected to the adhesion test (initial adhesion). The molded parts were additionally subjected to the above-described hydrolysis storage and adhesion was measured once again (adhesion after hydrolysis). For all measurements the same defect pattern was always observed in each case.

TABLE 1

| | Example 1 | Example 2 | | | Example 5 |
|---|---|---|---|---|---|
| | (according | (according | Example 3 | Example 4 | (according |
| | to the | to the | (com- | (com- | to the |
| | invention) | invention) | parative) | parative) | invention) |
| PC1 (% by | 60 | 100 | — | — | 95 |
| wt.) | | | | | |
| PC2 (% by | 40 | | 100 | — | — |
| wt.) | | | | | |
| PC3 (% by | — | — | — | 100 | — |
| wt.) | | | | | |
| PC4 (% by | — | — | — | — | 4.9 |
| wt.) | | | | | |
| GMS (% by | — | — | — | — | 0.1 |
| wt.) | | | | | |
| OH content | 1020 | 570 | 120 | 170 | 580 |
| (ppm) | | | | | |
| Initial | 6.5 | 6.5 | 1.0 | 6.1 | 6.4 |
| adhesion | | | | | |
| (MPa) | | | | | |
| Defect | Y | Y | A/B | Y | Y |
| pattern | | | | | |
| Adhesion | 4.1 | 3.1 | 0.9 | 1.0 | 3.3 |
| after | | | | | |
| hydrolysis | | | | | |
| 72 h (MPa) | | | | | |
| Defect | A/B | A/B | A/B | A/B | A/B |
| pattern after | | | | | |
| hydrolysis | | | | | |
| (MPa) | | | | | |

As is apparent from the results of table 1, component parts which have a phenolic OH group content according to the invention of the thermoplastic composition of the carrier exhibit an elevated composite adhesion coupled with a good defect pattern. Initial composite adhesion is higher for examples 1, 2 and 5 according to the invention than for comparative examples 3 and 4. At the same time all composite component parts according to the invention exhibit an elevated composite adhesion after hydrolysis storage.

It is likewise apparent from example 5 that the addition of the special hydroxyl components to the thermoplastic composition especially further improves composite adhesion after hydrolysis storage.

1. A process for producing a composite component part comprising
a) a carrier composed of a thermoplastic composition and
b) at least one polyurethane layer in direct contact with the carrier,
comprising the steps of
(ia) injecting a melt of a thermoplastic composition (Z) into a mold cavity followed by cooling to form the carrier or
(ib) introducing a film comprising an outer ply composed of a thermoplastic composition (Z) into a mold cavity, overmolding this film with a melt of a further thermoplastic composition (Z2) on the side facing away from the outer ply of the film followed by cooling to form the carrier,
wherein the thermoplastic composition (Z) contains
A) at least 95.0% by weight of an aromatic polycarbonate having a phenolic OH content of 230 ppm to 1500 ppm and
B) 0% to 5.0% by weight of at least one polymer additive and
wherein the further thermoplastic composition (Z2) may be the same as or different from the thermoplastic composition (Z),
(ii) enlarging the cavity of the mold and thus producing a gap or introducing the carrier into a second cavity of the mold which is larger than the first cavity in terms of its hollow mold dimensions, thus producing a gap, and wherein in case (ib) the carrier is oriented such that the outer ply of the film composed of the thermoplastic composition (Z) faces the gap,
(iii) injecting a reactive polyurethane raw material mixture containing
at least one polyisocyanate component,
at least one polyfunctional H-active compound and
optionally at least one polyurethane additive and/or processing auxiliary,
into the gap between the carrier and the mold surface, wherein the polyurethane raw material mixture undergoes polymerization to afford a compact polyurethane layer or to afford a polyurethane foam layer in contact with the surface of the carrier,
(iv) demolding the composite component part from the mold cavity.

2. The process as claimed in claim 1, characterized in that the aromatic polycarbonate of component A) has a phenolic OH content of 310 ppm to 1100 ppm.

3. The process as claimed in claim 1, characterized in that the aromatic polycarbonate of component A) comprises one, particularly preferably two or more of the following structures (4) to (7): 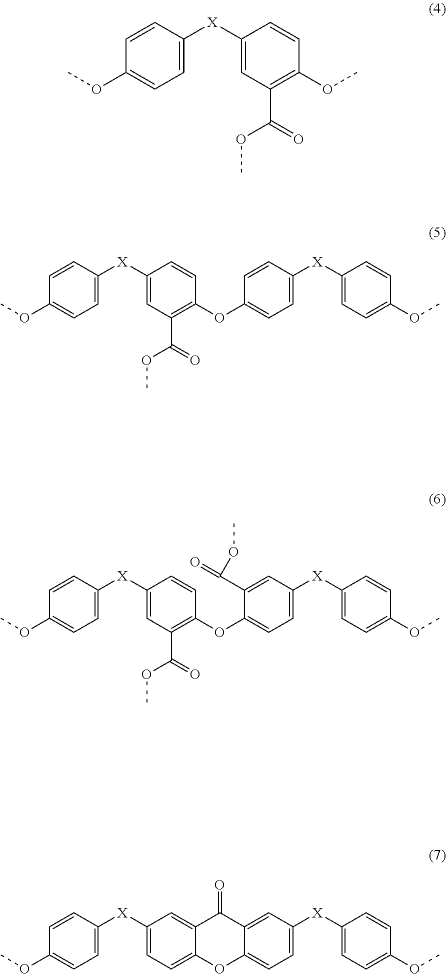
in which the phenyl rings may independently be mono- or disubstituted with C₁- to C₈-alkyl, halogen, preferably C₁- to C₄-alkyl, particularly preferably with methyl, and X represents a single bond, a linear or branched C₁- to C₆-alkylene group, a C₂- to C₁₀-alkylidene group or a C₅- to C₁₀-cycloalkylidene group, preferably represents a single bond or C₁- to C₄-alkylene and especially preferably isopropylidene and the “- - -” represent the bonding of the structures (4) to (7) into the aromatic polycarbonate.

4. The process as claimed in claim 3, characterized in that the amount of structural units (4) to (7) sums to 50 ppm to 1000 ppm.

5. The process as claimed in claim 1, characterized in that at least at one point the carrier has a wall thickness of 0.5 mm to 10 mm.

6. The process as claimed in claim 1, characterized in that the polyurethane layer has a layer thickness of 1 μm to 20 cm.

7. The process as claimed in claim 1, characterized in that the thermoplastic composition (Z) is composed of components A) and B).

8. The process as claimed in claim 1, characterized in that component B) is selected from the group consisting of least one representative of the group consisting of flame retardants, flame retardant synergists, smoke-inhibiting additives, anti-drip agents, internal and external lubricants and demolding agents, flowability aids, antistats, conductivity additives, nucleating agents, stabilizers, antibacterial additives, scratch resistance-improving additives, IR absorbers, optical brighteners, fluorescent additives, fillers and reinforcers, dyes and pigments and Brønsted-acidic compounds.

9. The process as claimed in claim 1, characterized in that a low-solvent reactive polyurethane raw material mixture having a solvent content of at most 10% by weight, preferably at most 2% by weight, particularly preferably at most 1% by weight, based on the lacquer proportion is used.

10. The process as claimed in claim 1, characterized in that a solvent-free reactive polyurethane raw material mixture is used.

11. The process as claimed in claim 1, characterized in that the reactive polyurethane raw material mixture has a pot life of at most 1 min, preferably at most 30 s, particularly preferably at most 10 s.

12. The process as claimed in claim 1, characterized in that the polymerization in process step (iii) is carried out under elevated pressure.

13. A composite component part comprising
a) a carrier composed of a thermoplastic composition (Z) containing
A) at least 95.0% by weight of an aromatic polycarbonate having a phenolic OH content of 230 ppm to 1500 ppm and
B) 0% to 5.0% by weight of at least one commercially available polymer additive,
b) at least one polyurethane layer in direct contact with the carrier,
produced by the process as claimed in claim 1.

14. The composite component part as claimed in claim 13, characterized in that it is an interior or exterior component part of a rail vehicle, aircraft or motor vehicle.

15. (canceled)
